(19) United States
(12) Patent Application Publication
(10) Pub. No.: US 2026/0365433 A1
(43) Pub. Date: Nov. 19, 2026

(54) WAREHOUSE MANAGEMENT APPARATUS, STORAGE BIN AGGREGATION METHOD, AND PROGRAM

(71) Applicant: Panasonic Intellectual Property Management Co., Ltd., Osaka (JP)

(72) Inventor: Ryosuke NASUNO, Kanagawa (JP)

(73) Assignee: Panasonic Intellectual Property Management Co., Ltd., Osaka (JP)

(21) Appl. No.: 19/536,621

(22) Filed: Feb. 11, 2026

(30) Foreign Application Priority Data
Mar. 19, 2025 (JP) 2025-044862

(51) Int. Cl. B65G 1/137; G06Q 10/063; G06Q 10/0631

(52) U.S. Cl. CPC B65G 1/1376; G06Q 10/063; G06Q 10/06315

(57) ABSTRACT

A warehouse management apparatus includes a processor, a memory, and a communication unit that performs communication with a warehouse management system that holds information related to one or more storage bins for accommodating articles to be stored in an automated warehouse. The processor cooperates with the memory to derive inventory turnover days of the articles accommodated in each of the storage bins based on information related to the plurality of storage bins received by the communication unit from the warehouse management system, determine a combination of a plurality of storage bins to be aggregated based on a result of deriving the inventory turnover days of the articles and filling rates of the articles in the storage bins, and transmit an execution instruction of aggregation based on the combination to a terminal gripped by a worker in the automated warehouse or a conveyance device moving in the automated warehouse.

### BACKGROUND

### 1. Technical Field

The present disclosure relates to a warehouse management apparatus, a storage bin aggregation method, and a program.

### 2. Description of the Related Art

PTL 1 discloses an automated warehouse control system provided with a warehouse computer and a terminal thereof in order to control an automated warehouse including a shelf that accommodates articles in units of buckets, a crane, and a station. The control system includes a consolidation processor provided in the warehouse computer in order to execute consolidation of transferring articles in a bucket as a consolidation source into a bucket as a consolidation destination and emptying the bucket as the consolidation source. The consolidation processor displays, on the terminal, a combination of buckets that can be consolidated in response to a request from the terminal, outputs a consolidation work list indicating a consolidation source bucket and a consolidation destination bucket from the terminal in accordance with a setting in the terminal for the displayed combination, and causes the consolidation source and consolidation destination buckets to be delivered to different stations by the crane.

### Citation List

### Patent Literature

PTL 1: Japanese Patent No. 3,700,300

### SUMMARY

The present disclosure has been devised in view of the above-described circumstances in the related art, and an object thereof is to efficiently realize aggregation of storage bins that store articles to be stored in an automated warehouse, and to improve operation efficiency of the storage bins.

The present disclosure provides a warehouse management apparatus including: a processor; a memory; and a communication unit that performs communication with a warehouse management system that holds information related to one or more storage bins for accommodating articles to be stored in an automated warehouse, in which the processor cooperates with the memory to derive inventory turnover days of the articles accommodated in each of the storage bins based on information related to the plurality of storage bins received by the communication unit from the warehouse management system, determine a combination of a plurality of storage bins to be aggregated based on a result of deriving the inventory turnover days of the articles and filling rates of the articles in the storage bins, and transmit an execution instruction of aggregation based on the combination to a terminal gripped by a worker in the automated warehouse or a conveyance device moving in the automated warehouse.

Also, the present disclosure provides a storage bin aggregation method including: causing a processor and a memory to cooperate to: perform communication with a warehouse management system that holds information related to one or more storage bins for accommodating articles to be stored in an automated warehouse; derive inventory turnover days of the articles accommodated in each of the storage bins based on the information related to the plurality of storage bins received from the warehouse management system; determine a combination of a plurality of storage bins to be aggregated based on a result of deriving the inventory turnover days of the articles and filling rates of the articles in the storage bins; and transmit an execution instruction of aggregation based on the combination to a terminal gripped by a worker in the automated warehouse or a conveyance device moving in the automated warehouse.

Moreover, the present disclosure provides a program that causes a warehouse management apparatus that is a computer to perform processing of: performing communication with a warehouse management system that holds information related to one or more storage bins for accommodating articles to be stored in an automated warehouse, deriving inventory turnover days of the articles accommodated in each of the storage bins based on the information related to the plurality of storage bins received from the warehouse management system, determining a combination of a plurality of storage bins to be aggregated based on a result of deriving the inventory turnover days of the articles and filling rates of the articles in the storage bins, and transmitting an execution instruction of aggregation based on the combination to a terminal gripped by a worker in the automated warehouse or a conveyance device moving in the automated warehouse.

Note that arbitrary combinations of the above-described constituent elements and implementations achieved by converting expressions of the present disclosure among the expressions for a method, a device, a system, a storage medium, a computer program, and the like are also effective as aspects of the present disclosure.

According to the present disclosure, it is possible to efficiently realize aggregation of storage bins that store articles stored in an automated warehouse and to improve operation efficiency of the storage bins.

### BRIEF DESCRIPTION OF THE DRAWINGS

FIG. 1 is a block diagram illustrating an overall outline of a warehouse system according to the present exemplary embodiment;

FIG. 2 is a block diagram illustrating a hardware configuration example of a warehouse management apparatus according to the present exemplary embodiment;

FIG. 3 is a diagram illustrating a data configuration example of a storage bin list acquired from a warehouse management system (WMS);

FIG. 4 is a diagram illustrating an example of inventory turnover days of articles accommodated in a storage bin;

FIG. 5 is a diagram illustrating another example of the inventory turnover days of articles accommodated in a storage bin;

FIG. 6 is a diagram illustrating a calculation example of an aggregation pair each including one slot;

FIG. 7 is a diagram illustrating a calculation example of an aggregation pair each including two slots;

FIG. 8 is a diagram schematically illustrating an aggregation example of the storage bins;

FIG. 9 is a diagram schematically illustrating an aggregation example of the storage bins;

FIG. 10 is a diagram schematically illustrating an aggregation example of the storage bins;

FIG. 11 is a diagram schematically illustrating an aggregation example of the storage bins;

FIG. 12 is a diagram schematically illustrating a work priority determination example based on filling rates;

FIG. 13 is a diagram schematically illustrating a work priority determination example based on inventory quantities; and

FIG. 14 is a flowchart illustrating an operation procedure example of the warehouse management apparatus according to the present exemplary embodiment in a time-series manner.

### DETAILED DESCRIPTIONS

### Background of Present Disclosure

In recent years, automated warehouses that store bins (which may also be referred to as “storage bins” below), which are boxes for accommodating one or more articles to be stored, in a plurality of regularly arranged shelves have started to be widely used. In an automated warehouse, a necessary storage bin is conveyed by a conveyance robot from a shelf to a work space called a station at the time of warehousing or delivery. In such an automated warehouse, there is an index of a filling rate indicating how much volume a storage bin is filled with articles, and the filling rate of the storage bin decreases if the articles are delivered. Therefore, in order to keep the filling rate high, it is necessary to aggregate storage bins accommodating the articles and to replenish the inventory. On the other hand, in a case where the filling rate of the storage bins cannot be kept high, storage efficiency of the automated warehouse as a whole decreases.

PTL 1 discloses so-called aggregation of a bucket as a consolidation source and a bucket as a consolidation destination. This aggregation is assumed to be executed by focusing on the number of articles accommodated in the buckets. However, there are days (hereinafter, referred to as “inventory turnover days”) from warehousing to delivery of the articles accommodated in the storage bins in the automated warehouse, and it may not be appropriate to perform the aggregation on the basis of only the number of accommodated articles depending on the inventory turnover days of the articles, and it is possible to state that there has been room for improvement in this regard.

Therefore, examples of a warehouse management apparatus, a storage bin aggregation method, and a program that efficiently realize aggregation of storage bins that store articles to be stored in an automated warehouse and improve operation efficiency of the storage bins will be described in the following exemplary embodiment.

An exemplary embodiment specifically disclosing the warehouse management apparatus, the storage bin aggregation method, and the program according to the present disclosure will be described in detail with reference to the drawings as appropriate. It is noted that a more detailed description than need may be omitted. For example, detailed descriptions of already well-known matters and duplicated descriptions of substantially the same configurations may be omitted. This is to avoid an unnecessarily redundant description below and to facilitate understanding of those skilled in the art. Note that the attached drawings and the following description are provided for those skilled in the art to fully understand the present disclosure, and are not intended to limit the subject matter as described in the appended claims. In the following description, the same elements may be denoted by the same reference signs, and descriptions thereof may be simplified or omitted.

### 1. Configuration Example of Warehouse System

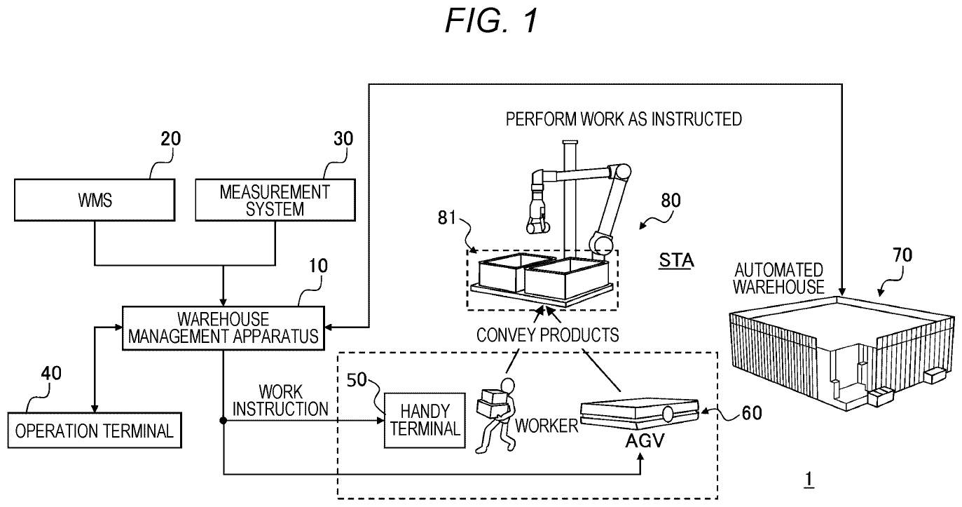

First, a configuration example of warehouse system 1 according to the present exemplary embodiment will be described with reference to FIG. 1. FIG. 1 is a block diagram illustrating an overall outline of warehouse system 1 according to the present exemplary embodiment. Warehouse system 1 includes warehouse management apparatus 10, warehouse management system (WMS) 20, measurement system 30, operation terminal 40, handy terminal 50, automated guide vehicle (AGV) 60, automated warehouse 70, and work robot 80. The components constituting warehouse system 1 are configured to be able to communicate data with each other via a wired or wireless network.

Warehouse management apparatus 10 is configured of, for example, a personal computer (PC) or a server computer. Warehouse management apparatus 10 determines whether to aggregate articles accommodated in each of one or more storage bins stored in automated warehouse 70 (for example, products stored until delivery after warehousing) into another storage bin, using data (for example, inventory turnover days, filling rate) calculated on the basis of data obtained through data communication with WMS 20 or measurement system 30. It is determined that the articles are to be aggregated, warehouse management apparatus 10 generates an execution instruction of aggregation indicating which storage bin of the articles and which storage bin of the articles are to be aggregated, and transmits the execution instruction of aggregation to handy terminal 50 or AGV 60. Details of the processing of warehouse management apparatus 10 will be described later.

WMS 20 is a so-called warehouse management system and includes, for example, a database that manages the inventory quantity of articles stored in automated warehouse 70, the statuses of entering and exiting (warehousing, delivery) of the articles, and statuses of movement of the articles. In this database, data of each item such as a name, a size (dimension), a weight, a warehousing date, and a scheduled delivery date is managed for each article. WMS 20 may acquire and manage instructions related to warehousing and delivery of articles and data regarding various facilities and resources in automated warehouse 70 including handy terminal 50 and AGV 60.

Measurement system 30 is configured of, for example, red green blue depth (RGBD) cameras arranged at various places in automated warehouse 70. Measurement system 30 images each storage bin stored in automated warehouse 70 as an object and measures color information and depth information of the storage bin by analyzing the captured image. More specifically, measurement system 30 measures the distance from an RGBD camera to the surface of articles in the storage bin as an example of the depth information. Measurement system 30 derives, for each storage bin, the proportion at which the articles accommodated in the storage bin are accommodated in the storage bin (hereinafter, referred to as a “filling rate”) on the basis of the measured value. Measurement system 30 sends the measured value of the filling rate for each storage bin to warehouse management apparatus 10.

Operation terminal 40 is configured of, for example, a personal computer, a smartphone, or a tablet terminal. In automated warehouse 70, operation terminal 40 functions as an input device that performs an input operation on warehouse management apparatus 10, and also functions as an output device that outputs data from warehouse management apparatus 10.

Handy terminal 50 is a portable computer device gripped by a worker who performs various types of work executed in automated warehouse 70. When handy terminal 50 receives the execution instruction of aggregation sent from warehouse management apparatus 10, then handy terminal 50 provides a notification through sound or a screen. In this manner, the worker can recognize that it is necessary to aggregate the storage bins designated by the execution instruction of aggregation.

AGV 60 is a robot for conveying storage bins in automated warehouse 70 to a predetermined position on the basis of an instruction from warehouse management apparatus 10 or an external system (not illustrated). Once AGV 60 receives an execution instruction of aggregation sent from warehouse management apparatus 10, for example, AGV 60 moves to a shelf in automated warehouse 70 where a corresponding storage bin is arranged, and conveys the storage bin to a place called station STA where aggregation processing is to be executed. Note that the aggregation processing may be executed at a place other than station STA. Note that AGV 60 may move between shelves constituting automated warehouse 70 or may stand by at a current position. AGV 60 includes, for example, a traveling unit for performing an operation related to movement, a sensor for acquiring peripheral information, a communication unit for transmitting and receiving data such as an execution instruction to and from warehouse management apparatus 10, and the like.

Automated warehouse 70 is configured to be capable of accommodating one or more storage bins capable of accommodating articles, and conveys the storage bins to a target position using AGV 60 in response to a request from warehouse management apparatus 10. Note that the conveyance of the storage bins is not limited to the one using AGV 60. For example, the storage bins may be conveyed using a belt conveyor or the like. Automated warehouse 70 is configured by, for example, a grid-shaped frame so as to be able to accommodate the plurality of storage bins. In addition, the storage bins may include not only storage bins in which the articles are accommodated but also empty storage bins in a state where no articles are accommodated therein and storage bins in a state where articles to be accommodated therein have not been determined. Note that the bins used in automated warehouse 70 may include not only the storage bins described above but also, for example, delivery bins that collectively accommodate a plurality of articles at the time of delivery from automated warehouse 70 according to order information input to warehouse management apparatus 10. The following description will be given on the assumption that the storage bins have a rectangular box-shaped configuration.

Work robot 80 is disposed in station STA, and performs pick-and-place of transferring articles (for example, products) accommodated in storage bins 81 that have been conveyed to station STA to delivery bins (see the above description). Note that at the position where work robot 80 is disposed in station STA, the worker directly brings the articles and adds the articles to storage bins 81, or storage bins 81 themselves with the articles accommodated therein are conveyed by AGV 60.

### 2. Hardware Configuration Example of Warehouse Management Apparatus

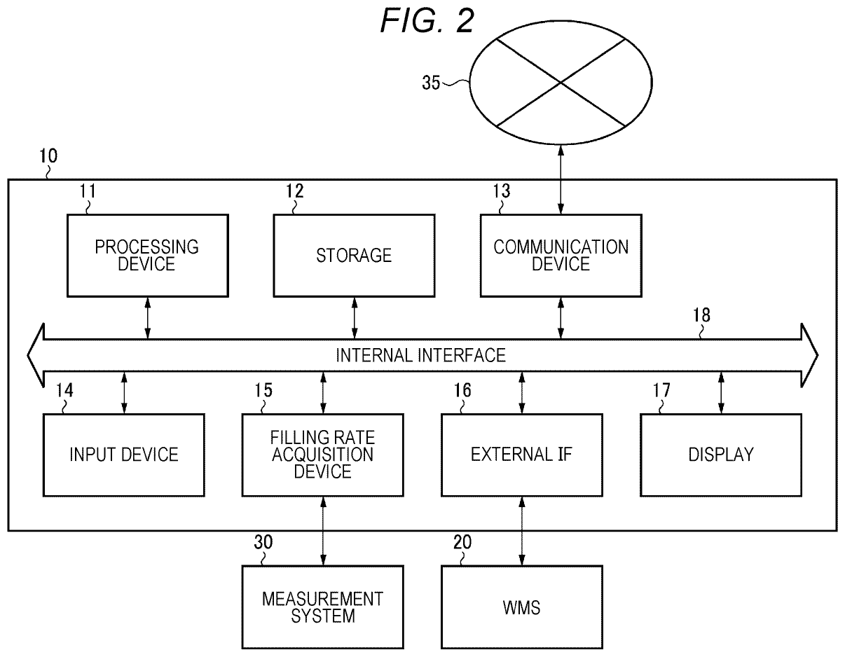

Next, a hardware configuration example of warehouse management apparatus 10 according to the present exemplary embodiment will be described with reference to FIG. 2. FIG. 2 is a diagram illustrating a block diagram illustrating a hardware configuration example of warehouse management apparatus 10 according to the present exemplary embodiment. Warehouse management apparatus 10 includes processing device 11, storage 12, communication device 13, input device 14, filling rate acquisition device 15, external IF 16, and display 17. Each part is configured to be able to communicate data with each other via internal interface 18.

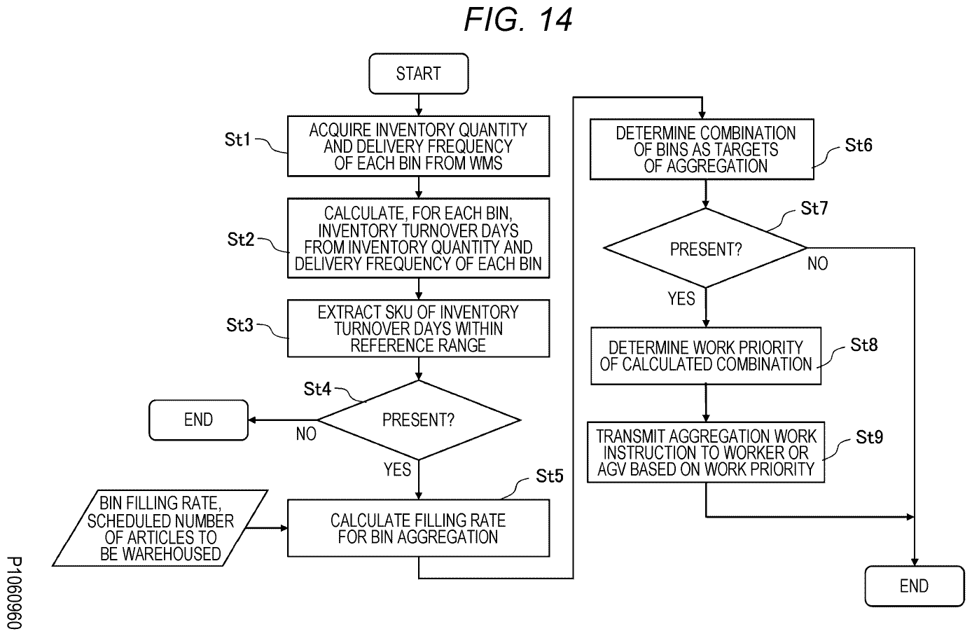

Processing device 11 is configured of a processor such as a central processing unit (CPU), a graphical processing unit (GPU), a micro processing unit (MPU), a digital signal processor (DSP), or a field-programmable gate array (FPGA), for example. Processing device 11 realizes various kinds of processing (a series of processing illustrated in FIG. 14, for example) by referring to and reading various programs and data stored in storage 12, for example.

Storage 12 is a memory for storing the various kinds of data, programs, and the like and may be configured of a volatile or non-volatile storage device such as a random access memory (RAM), a read only memory (ROM), a hard disk drive (HDD), or a solid state drive (SSD), for example.

Communication device 13 is an interface for communicating with an external device via network 35. The communication standard that can be supported by communication device 13 is not particularly limited, and it may be wired or wireless. The communication device may be compatible with a plurality of communication standards. Thus, network 35 may be configured by combining networks based on a plurality of communication standards.

Input device 14 receives operations and instructions from users (an administrator, a worker, for example) of the warehouse. Input device 14 may include a mouse, a keyboard, a touch panel display, and the like. Note that operation terminal 40 may be configured as input device 14.

Filling rate acquisition device 15 is an interface circuit capable of performing data communication with measurement system 30 directly or via network 35, receives and acquires data of the filling rate of each storage bin sent from measurement system 30, and sends the data to processing device 11. Note that filling rate acquisition device 15 may acquire a captured image in automated warehouse 70 captured by measurement system 30, or a captured image of storage bins, delivery bins, or the like captured by a camera installed in work robot 80 arranged in station STA or the like.

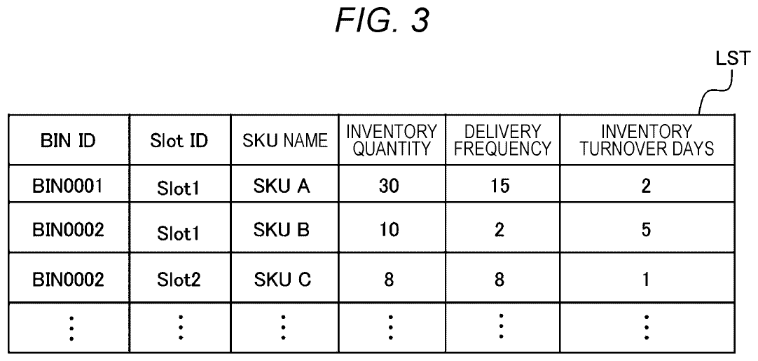

External IF 16 includes an interface circuit capable of performing data communication with WMS 20 directly or via network 35. External IF 16 receives various kinds of data (for example, refer to the data of the storage bin list illustrated in FIG. 3 and the data of the filling rate theoretically calculated for each storage bin) sent from WMS 20 and sends the data to processing device 11.

Display 17 displays a display screen serving as various user interfaces generated mainly by processing device 11 for the user. Display 17 may include, for example, a liquid crystal display or a touch panel display.

### 3. Aggregation of Storage Bins

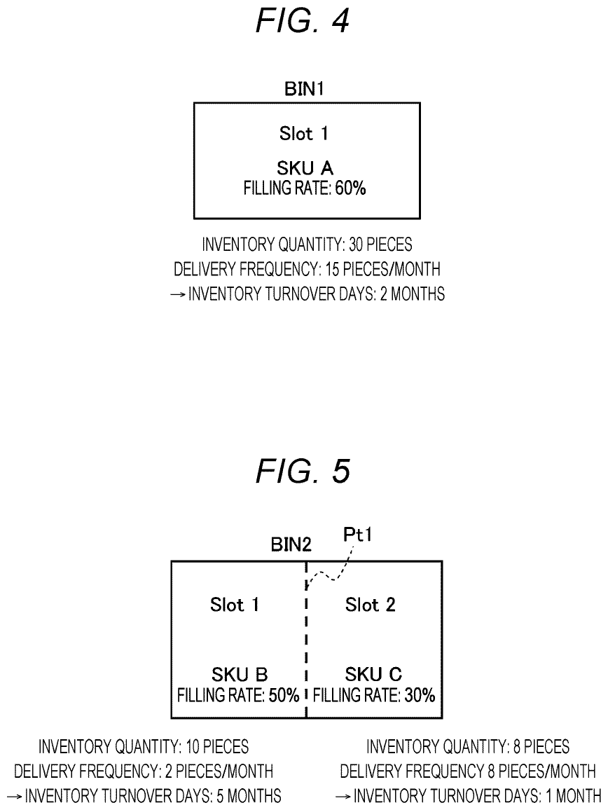

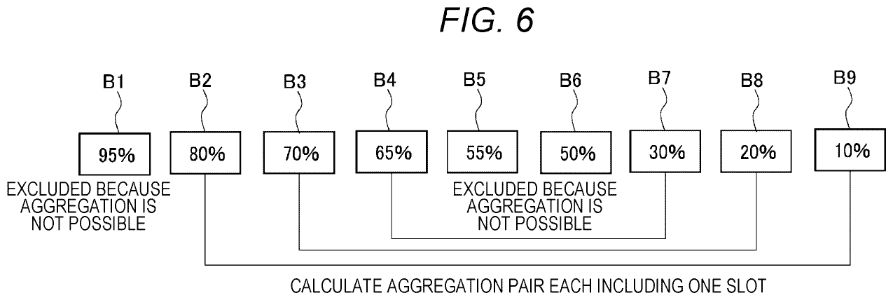

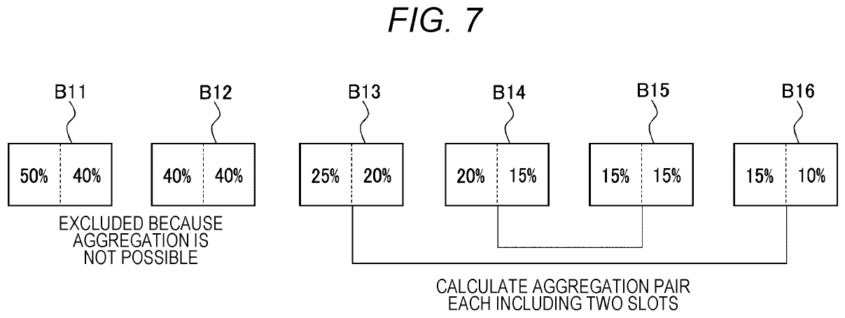

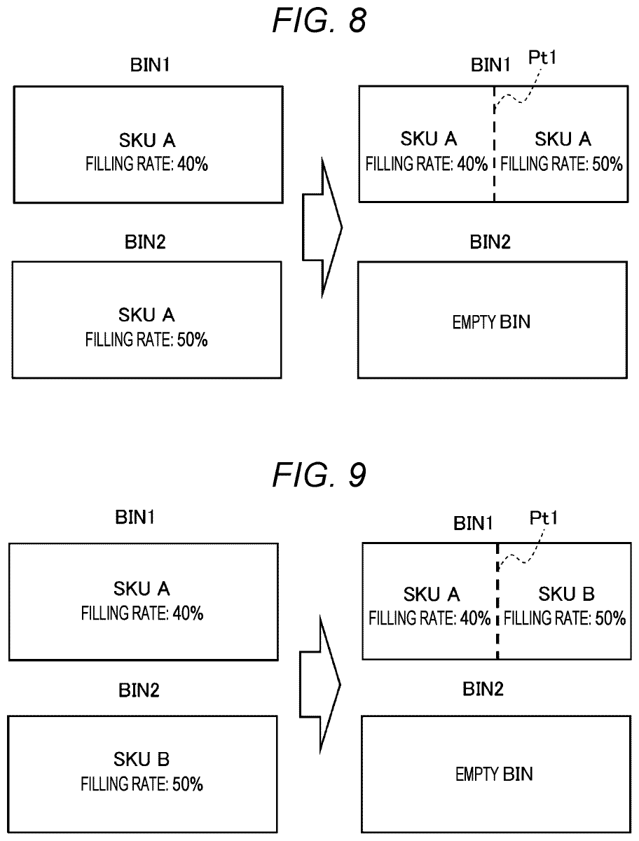

Next, aggregation of the storage bins will be described with reference to FIGS. 3 to 11. FIG. 3 is a diagram illustrating a data configuration example of storage bin list LST acquired from WMS 20. FIG. 4 is a diagram illustrating an example of inventory turnover days of articles accommodated in a storage bin. FIG. 5 is a diagram illustrating another example of inventory turnover days of articles accommodated in a storage bin. FIG. 6 is a diagram illustrating a calculation example of an aggregation pair each including one slot. FIG. 7 is a diagram illustrating a calculation example of an aggregation pair each including two slots. FIGS. 8, 9, 10, and 11 are diagrams schematically illustrating aggregation examples of the storage bins.

The following description will be exemplified by defining a constituent unit of articles accommodated in a storage bin as a stock keeping unit (SKU). SKU is a unit for counting the minimum number of items in inventory management, in other words, a minimum identification unit of an article or an article group in automated warehouse 70.

Storage bin list LST acquired by warehouse management apparatus 10 from WMS 20 includes data of various items managed for each storage bin by WMS 20. As illustrated in FIG. 3, for example, storage bin list LST includes identification information (SLOT ID) of a slot in a storage bin, an SKU name, an inventory quantity, a delivery frequency, and inventory turnover days for identification information (BIN ID) of the storage bin. The slot indicates at least one accommodating space provided in the storage bin. In other words, the articles (SKU) are allocated and accommodated in slots of the storage bins. Note that at the timing at which warehouse management apparatus 10 acquires storage bin list LST from WMS 20, the column of the inventory turnover days may be blank except for a case where the inventory turnover days are calculated in advance by WMS 20. In other words, the inventory turnover days may be calculated by WMS 20 or may be calculated by warehouse management apparatus 10.

FIG. 4 illustrates both the filling rate and the inventory turnover days of articles (SKU name: SKU A) in a storage bin in the first row (BIN ID: BIN0001) of storage bin list LST in FIG. 3. In FIG. 4, “BIN0001” which is the BIN ID in FIG. 3 is described as “BIN1” for convenience, and one slot (Slot1) is provided in storage bin BIN1. The value of the filling rate may be, for example, a value (60%) theoretically calculated by WMS 20 on the basis of the current inventory quantity (30 pieces) among the maximum number of articles (SKU A) that can be accommodated in storage bin BIN1, or may be a measurement value (60%) derived by measurement system 30. Processing device 11 of warehouse management apparatus 10 calculates the inventory turnover days of the articles (SKU A) accommodated in storage bin BIN1 as “2” (=30/15) on the basis of storage bin list LST.

Here, the inventory turnover days are the number of days required until all the articles (SKU) accommodated in the storage bin are delivered, and the unit thereof is, for example, “month”. Note that the unit may be “day”. In the example of FIG. 4, the inventory turnover days of the articles (SKU A) are two months because the inventory quantity is 30 pieces and the delivery frequency per month is 15 pieces.

FIG. 5 illustrates both the filling rates and the inventory turnover days of articles (SKU names: SKU B, SKU C) in storage bins in the second row (BIN ID: BIN0002) and in the third row (BIN ID: BIN0002) of storage bin list LST in FIG. 3. In FIG. 5, “BIN0002” which is the BIN ID in FIG. 3 is described as “BIN2” for convenience, and two slots (Slot1, Slot2) are provided in the storage bin BIN2 with one partitioning plate Pt1 in between. The value of the filling rate of slot Slot1 may be, for example, a value (50%) theoretically calculated by WMS 20 on the basis of the current inventory quantity (10 pieces) among the maximum number of articles (SKU B) that can be accommodated in slot Slot1, or may be a measurement value (50%) derived by measurement system 30. Similarly, the value of the filling rate of slot Slot2 may be, for example, a value (30%) theoretically calculated by WMS 20 on the basis of the current inventory quantity (8 pieces) among the maximum number of articles (SKU C) that can be accommodated in slot Slot2, or may be a measurement value (30%) derived by measurement system 30. Processing device 11 of warehouse management apparatus 10 calculates the inventory turnover days of the articles (SKU B) accommodated in slot Slot1 of storage bin BIN2 as “5” (=10/2) on the basis of storage bin list LST. Furthermore, processing device 11 of warehouse management apparatus 10 calculates the inventory turnover days of the articles (SKU C) accommodated in slot Slot2 of storage bin BIN2 as “1” (=8/8) on the basis of storage bin list LST.

In a case where one slot is provided in one storage bin as described above (see FIG. 4), warehouse management apparatus 10 calculates, for the slot (that is, the storage bin), the inventory turnover days of the articles (SKU) accommodated in the storage bin. In addition, in a case where a plurality of slots are provided in one storage bin, warehouse management apparatus 10 calculates, for each slot, the inventory turnover days of the articles (SKU) accommodated in the slot. After calculating the inventory turnover days of the articles (SKU), warehouse management apparatus 10 may additionally update the calculation result in the column of the inventory turnover days in storage bin list LST.

Warehouse management apparatus 10 updates each value in storage bin list LST once a day or by being triggered by the articles being delivered from automated warehouse 70. With this storage bin list LST, warehouse management apparatus 10 can accurately determine, for each of all the storage bins stored in automated warehouse 70 or each of the slots provided in the storage bins, the inventory turnover days of the articles (SKU) accommodated in the storage bin or the slot.

Warehouse management apparatus 10 extracts storage bins (specifically, BIN IDs of the storage bins) that can be targets of aggregation on the basis of the result of determining the inventory turnover days. The storage bins to be aggregated are storage bins accommodating articles (SKU) with inventory turnover days within a predetermined range (within a range of three months to six months, for example) determined by the user such as an administrator in advance and input as setting values from operation terminal 40.

Excessively fast inventory turnover (in other words, excessively short inventory turnover days) leads not only to an increase in number of works required to aggregate the storage bins (that is, to aggregate the articles (SKU) accommodated in the storage bins) but also to a short effect duration time of the aggregation, and there are not many advantages of the aggregation. On the other hand, excessively slow inventory turnover (in other words, excessively long inventory turnover days) leads to an increase in number of works required for stocktaking annually performed in automated warehouse 70, and there are not many advantages in this case as well. Therefore, the storage bins to be aggregated within a predetermined range are extracted.

FIG. 6 illustrates a state where a plurality of storage bins each having only one slot are aligned. The filling rate for aggregation (see the following description) calculated by processing device 11 of warehouse management apparatus 10 is associated with each of storage bins B1, B2, B3, B4, B5, B6, B7, B8, B9. In other words, the filling rate for aggregation (95%) of storage bin B1, the filling rate for aggregation (80%) of storage bin B2, the filling rate for aggregation (70%) of storage bin B3, the filling rate for aggregation (65%) of storage bin B4, the filling rate for aggregation (55%) of storage bin B5, the filling rate for aggregation (50%) of storage bin B6, the filling rate for aggregation (30%) of storage bin B7, the filling rate for aggregation (20%) of storage bin B8, and the filling rate for aggregation (10%) of storage bin B9 are illustrated. Processing device 11 of warehouse management apparatus 10 uses, as restriction conditions, (1) the condition that it is possible to secure at least one empty slot after the aggregation and (2) the condition that the total value of the filling rates for aggregation does not exceed 100% as a result of the aggregation, and searches for and extracts a combination of storage bins satisfying the restriction conditions.

As a result, processing device 11 of warehouse management apparatus 10 determines to set a total of three pairs, namely a pair of storage bins B2, B9, a pair of storage bins B3, B8, and a pair of storage bins B4, B7 as targets of aggregation as illustrated in FIG. 6. Note that since storage bin B1 alone has a filling rate for aggregation of 95%, and further, the sum of the filling rates for a pair of storage bins B5, B6 exceeds 100%, each of storage bins B1, B5, B6 does not satisfy the above-mentioned restriction conditions and is not selected as a target of aggregation.

FIG. 7 illustrates a state where a plurality of storage bins each including two slots are aligned. The filling rate for aggregation (see the following description) calculated by processing device 11 of warehouse management apparatus 10 is associated with each of storage bins B11, B12, B13, B14, B15, B16. In other words, the filling rates for aggregation (50%, 40%) of storage bin B11, the filling rates for aggregation (40%, 40%) of storage bin B12, the filling rates for aggregation (25%, 20%) of storage bin B13, the filling rates for aggregation (20%, 15%) of storage bin B14, the filling rates for aggregation (15%, 15%) of storage bin B15, and the filling rates for aggregation (15%, 10%) of storage bin B16 are illustrated. It shows that in regard to the filling rates for aggregation of storage bin B11, the filling rate for aggregation of one of the two provided slots is 50%, and the filling rate for aggregation of the other slot is 40%, and the same applies to the other storage bins B12 to B16. Processing device 11 of warehouse management apparatus 10 uses, as restriction conditions, (1) the condition that it is possible to secure at least one empty slot after the aggregation and (2) the condition that the total value of the filling rates for aggregation does not exceed 100% as a result of the aggregation, and searches for and extracts a combination of storage bins satisfying the restriction conditions.

As a result, processing device 11 of warehouse management apparatus 10 determines to set a total of two pairs, namely a pair of storage bins B13, B16 and a pair of storage bins B14, B15 as targets of aggregation as illustrated in FIG. 7. Note that since the sum of the filling rates for aggregation exceeds 100% if each of storage bins B11, B12 is aggregated with the other storage bins B13 to B16, each of storage bins B11, B12 cannot satisfy the above-mentioned restriction conditions and is not selected as a target of aggregation.

FIGS. 8 to 11 illustrate examples of aggregation patterns of the storage bins.

In the example of FIG. 8, each of both storage bins BIN1, BIN2 has only one slot, and the filling rate for aggregation of the articles (SKU A) in storage bin BIN1 is 40%, while the filling rate for aggregation of the articles (SKU A) in storage bin BIN2 is 50%. Partitioning plate Pt1 is arranged in storage bin BIN1, and a total of two slots are provided through the aggregation of storage bins BIN1 and BIN2. Furthermore, the articles (SKU A) originally accommodated in storage bin BIN1 are maintained as they are at the proportion of the filling rate for aggregation of 40% in one of the slots, and the articles (SKU A) of the same kind accommodated in storage bin BIN2 are accommodated at the proportion of the filling rate for aggregation of 50% in the other slot. In this manner, the articles are stored in storage bin BIN1 at the filling rate for aggregation of 90%, which is a relatively high filling rate, which leads not only to an improvement in storage efficiency but also to effective utilization of storage bin BIN2 that becomes an empty bin in automated warehouse 70.

In the example of FIG. 9, each of both storage bins BIN1, BIN2 has only one slot, and the filling rate for aggregation of the articles (SKU A) in storage bin BIN1 is 40%, while the filling rate for aggregation of the articles (SKU B) in storage bin BIN2 is 50%. Partitioning plate Pt1 is arranged in storage bin BIN1, and a total of two slots are provided through the aggregation of storage bins BIN1 and BIN2. Furthermore, the articles (SKU A) originally accommodated in storage bin BIN1 are maintained as they are at the proportion of the filling rate for aggregation of 40% in one of the slots, and another kind of articles (SKU B) accommodated in storage bin BIN2 are accommodated at the proportion of the filling rate for aggregation of 50% in the other slot. In this manner, the articles are stored in storage bin BIN1 at the filling rate for aggregation of 90%, which is a relatively high filling rate, which leads not only to an improvement in storage efficiency but also to effective utilization of storage bin BIN2 that becomes an empty bin in automated warehouse 70.

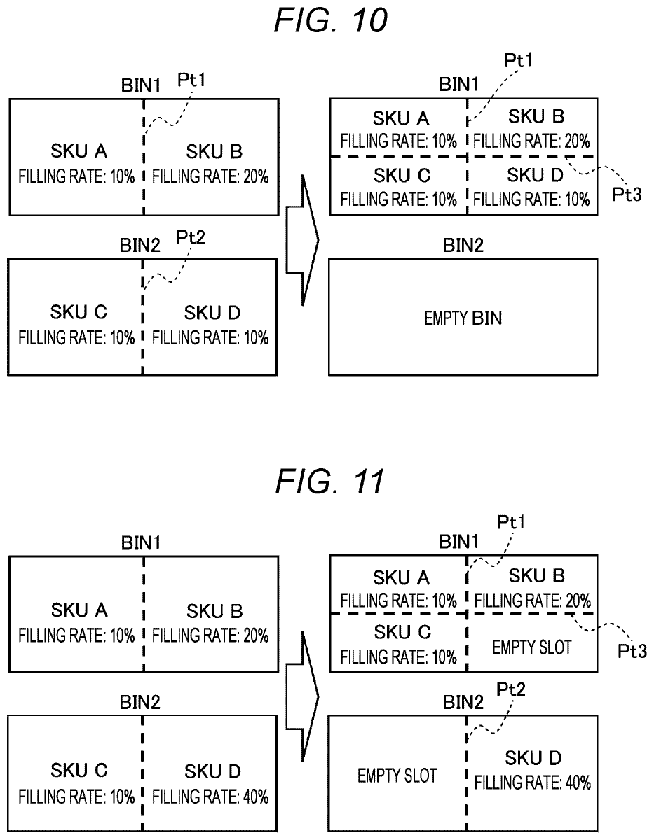

In the example of FIG. 10, each of both storage bins BIN1, BIN2 has two slots with partitioning plates Pt1, Pt2 in between, respectively. The filling rate for aggregation of the articles (SKU A) accommodated in one of the slots in storage bin BIN1 is 10%, and the filling rate for aggregation of the articles (SKU B) accommodated in the other slot is 20%. The filling rate for aggregation of articles (SKU C) accommodated in one of the slots in storage bin BIN2 is 10%, and the filling rate for aggregation of articles (SKU D) accommodated in the other slot is 10%. Partitioning plates Pt1, Pt3 are arranged in storage bin BIN1, and a total of four slots are provided through the aggregation of storage bins BIN1, BIN2. Furthermore, the articles (SKU A) originally accommodated in storage bin BIN1 are maintained as they are at the proportion of the filling rate for aggregation of 10% in the first slot, another kind of articles (SKU B) originally accommodated in storage bin BIN1 are accommodated at the proportion of the filling rate for aggregation of 20% in the second slot, another kind of articles (SKU C) accommodated in storage bin BIN2 are accommodated at the proportion of the filling rate for aggregation of 10% in the third slot, and another kind of articles (SKU D) accommodated in storage bin BIN2 are accommodated at the proportion of the filling rate for aggregation of 10% in the fourth slot. In this manner, storage bin BIN1 can store multiple kinds of articles at the filling rate for aggregation of 50%, which leads not only to an improvement in storage efficiency but also to effective utilization of storage bin BIN2 that becomes an empty bin in automated warehouse 70.

In the example of FIG. 11, each of both storage bins BIN1, BIN2 has two slots with partitioning plates Pt1, Pt2 in between, respectively. The filling rate for aggregation of the articles (SKU A) accommodated in one of the slots in storage bin BIN1 is 10%, and the filling rate for aggregation of the articles (SKU B) accommodated in the other slot is 20%. The filling rate for aggregation of articles (SKU C) accommodated in one of the slots in storage bin BIN2 is 10%, and the filling rate for aggregation of articles (SKU D) accommodated in the other slot is 40%. Partitioning plates Pt1, Pt3 are arranged in storage bin BIN1, and a total of four slots are provided through the aggregation of storage bins BIN1, BIN2. In a case where a total of four slots are provided in one storage bin, the condition that the filling rate for aggregation of each slot is 25% at maximum is a restriction condition, and it is not possible to accommodate articles at a filling rate for aggregation exceeding 25%. Furthermore, the articles (SKU A) originally accommodated in storage bin BIN1 are maintained as they are at the proportion of the filling rate for aggregation of 10% in the first slot, another kind of articles (SKU B) originally accommodated in storage bin BIN1 are accommodated at the proportion of the filling rate for aggregation of 20% in the second slot, another kind of articles (SKU C) accommodated in storage bin BIN2 are accommodated at the proportion of the filling rate for aggregation of 10% in the third slot, and the fourth slot becomes an empty slot. This is because the articles (SKU D) have been accommodated at the filling rate for aggregation of 40%, and if it is attempted to accommodate the articles in the fourth slot of storage bin BIN1, the upper limit (25%) of the filling rate for aggregation of each slot in storage bin BIN1 is exceeded. Therefore, another kind of articles (SKU D) accommodated in storage bin BIN2 are accommodated as they are in the second slot of storage bin BIN2 at the proportion of the filling rate for aggregation of 40% and do not become targets of aggregation with storage bin BIN1. In this manner, storage bin BIN1 can store more kinds of articles than those of articles accommodated before the aggregation, which leads not only to an improvement in storage efficiency but also to effective utilization of some of the slots that become empty slots in storage bin BIN2 in automated warehouse 70.

### 4. Work Priority in Aggregation

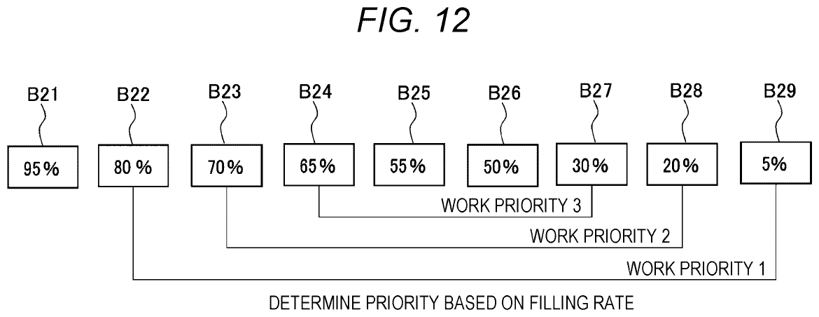

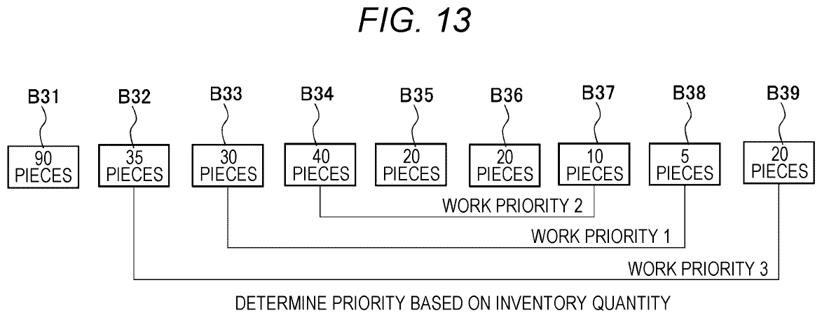

Next, work priority in aggregation will be described with reference to FIGS. 12 and 13. In other words, from which pair of storage bins the worker or AGV 60 may preferentially execute aggregation with higher in a case where a plurality of pairs of storage bins are present as targets of the aggregation will be described. FIG. 12 is a diagram schematically illustrating a work priority determination example based on filling rates. FIG. 13 is a diagram schematically illustrating a work priority determination example based on inventory quantities.

The work priority is an order indicating from which pair of storage bins the worker or AGV 60 is to preferentially execute aggregation in a case where a plurality of pairs of storage bins are present as targets of the aggregation. There are two ways of determining the work priority, namely a method based on the filling rates (see FIG. 12) and a method based on the inventory quantities of the articles (SKU) (see FIG. 13). Each of the methods will be described.

Processing device 11 of warehouse management apparatus 10 determines the work priority of the pairs of storage bins as targets of the aggregation on the basis of the work priority determination criteria described below.

### Work Priority Determination Criteria

(1) Work priority of pairs that can create empty bins is set to be high, and work priority of pairs that can create empty slots is set to be low.
(2) In a case where articles in one of each pair of storage bins with a lower filling rate for aggregation or a smaller inventory quantity are assumed to be articles (SKU) to be moved at the time of aggregation, the pairs of the storage bins are sorted in the order from lower filling rates for aggregation or from smaller inventory quantities of the articles (SKU) to be moved, and higher work priority is set for the pairs of storage bins with smaller amounts of movement.

As illustrated in FIG. 12, the filling rates for aggregation of storage bins B21, B22, B23, B24, B25, B26, B27, B28, B29 are 95%, 80%, 70%, 65%, 55%, 50%, 30%, 20%, 5%, respectively. Furthermore, three combinations of a pair of storage bins B22, B29, a pair of storage bins B23, B28, and a pair of storage bins B24, B26 are targets of the aggregation. Processing device 11 of warehouse management apparatus 10 determines that the work priority of the pair of storage bins B29, B22 constituting a pair with storage bin B29 with the lowest filling rate for aggregation of the articles (SKU) to be moved (in other words, the smallest number of works for the aggregation) is the highest on the basis of the above-mentioned work priority determination criteria. Next, processing device 11 of warehouse management apparatus 10 determines that the work priority of the pair of storage bins B28, B23 similarly constituting a pair with storage bin B28 with the second lowest filling rate for aggregation of the articles (SKU) to be moved (in other words, the second smallest number of works for the aggregation) is the second highest. Finally, processing device 11 of warehouse management apparatus 10 determines that the work priority of the pair of storage bins B27, B24 similarly constituting a pair with storage bin B27 with the third lowest filling rate for aggregation of the articles (SKU) to be moved (in other words, the third smallest number of works for the aggregation) is the third highest.

As illustrated in FIG. 13, the inventory quantities of the articles (SKU) of storage bins B31, B32, B33, B34, B35, B36, B37, B38, B39 are 90 pieces, 35 pieces, 30 pieces, 40 pieces, 20 pieces, 20 pieces, 10 pieces, 5 pieces, 20 pieces, respectively. Furthermore, three combinations of a pair of storage bins B32, B39, a pair of storage bins B33, B38, and a pair of storage bins B34, B37 are targets of the aggregation. Processing device 11 of warehouse management apparatus 10 determines that the work priority of the pair of storage bins B38, B33 constituting a pair with storage bin B38 with the smallest inventory quantity of the articles (SKU) to be moved (in other words, the smallest number of works for the aggregation) is the highest on the basis of the above-mentioned work priority determination criteria. Next, processing device 11 of warehouse management apparatus 10 determines that the work priority of the pair of storage bins B37, B34 similarly constituting a pair with storage bin B37 with the second smallest inventory quantity of the articles (SKU) to be moved (in other words, the second smallest number of works for the aggregation) is the second highest. Finally, processing device 11 of warehouse management apparatus 10 determines that the work priority of the pair of storage bins B39, B32 similarly constituting a pair with storage bin B39 with the third smallest inventory quantity of the articles (SKU) to be moved (in other words, the third smallest number of works for the aggregation) is the third highest.

### 5. Operation Example of Warehouse Management Apparatus

Next, an operation procedure of warehouse management apparatus 10 according to the present exemplary embodiment will be described with reference to FIG. 14. FIG. 14 is a flowchart illustrating an operation procedure example of warehouse management apparatus 10 according to the present exemplary embodiment in a time-series manner. A series of processing illustrated in FIG. 14 is executed by processing device 11 of warehouse management apparatus 10.

In FIG. 14, processing device 11 receives and acquires data of storage bin list LST (see FIG. 3) containing data of each of items of the inventory quantity and the delivery frequency for each bin from WMS 20 (St1). Processing device 11 calculates inventory turnover days of the articles (SKU) on the basis of the inventory quantity and the delivery frequency of the articles (SKU) for each storage bin in storage bin list LST acquired in step St1 (St2). Processing device 11 extracts information of the articles (SKU), for which the inventory turnover days have been calculated as falling within a predetermined range (three months to six months, for example) in step St2 (St3). In a case where the extraction result in step St3 is present (St4, YES), processing of processing device 11 proceeds to step St5. On the other hand, in a case where there is no extraction result in step St3 (St4, NO), it is determined that there are no storage bins as targets of the aggregation, and the processing of processing device 11 is ended.

Processing device 11 determines, for each storage bin to accommodate the articles (SKU) extracted in step St3, whether the inventory quantity of articles to be delivered on the day can be warehoused for replenishing the same storage bin or the articles are to be newly warehoused in a new storage bin on the basis of the filling rate of the storage bin and the scheduled inventory quantity of the articles to be warehoused in automated warehouse 70 on the day. In the case of warehousing for replenishment, processing device 11 calculates the filling rate for aggregation of the storage bin by adding the current filling rate of the storage bin and the filling rate corresponding to the scheduled number of articles to be warehoused (St5). In the case of new warehousing, processing device 11 calculates, as the filling rate for aggregation, a filling rate in a case where the articles are accommodated in one storage bin as usual (St5).

In a case where the current filling rate of the storage bin is 50% and the filling rate corresponding to the scheduled number of articles to be warehoused on the day is 30%, for example, processing device 11 determines that replenishment warehousing is possible because the added filling rates do not exceed 100%, and calculates the filling rate for aggregation as 80% (=50%+30%). Note that the filling rate corresponding to the scheduled number of articles to be warehoused may be obtained using a calculation expression of (the current filling rate of the storage bin/the inventory quantity)×the scheduled number of articles to be warehoused, or a filling rate measured from the scheduled number of articles to be warehoused on the day by measurement system 30 may be used.

In a case where the current filling rate of the storage bin is 80% and the filling rate corresponding to the scheduled number of articles to be warehoused on the day is 50%, for example, processing device 11 determines that replenishment warehousing is not possible because the added filling rates exceed 100%, and calculates the filling rate for aggregation as 50%, which is the filling rate corresponding to the scheduled number of articles to be warehoused on the day.

Note that the example has been described above in which processing device 11 adds the filling rate corresponding to the scheduled number of articles to be warehoused on the day to the current filling rate of the storage bin and then determines which of the replenishment warehousing in the existing storage bin and the allocation of the articles to the new storage bin is to be performed. However, processing device may add not only the filling rate corresponding to the scheduled number of articles to be warehoused on the day but also the filling rate corresponding to the scheduled inventory quantity in the future (one week later, for example) that has already been registered in WMS 20 to the current filling rate of the storage bin and determine which of the replenishment warehousing in the existing storage bin and the allocation of the articles to the new storage bin is to be performed. In this manner, processing device 11 can appropriately take into account the scheduled number of articles to be warehoused in the future that is currently registered in WMS 20 and then determine whether or not to aggregate the storage bin.

Processing device 11 uses the result of calculating the filling rates for aggregation of the storage bins and determines a combination (pair) of storage bins that can be targets of the aggregation (St6). Processing device 11 determines a pair of storage bins that satisfy predetermined restriction conditions and can be targets of the aggregation by searching for storage bins with low filling rates for aggregation using a storage bin with a high filling rate for aggregation, for example, as a core. Note that processing device 11 may determine a pair of storage bins that satisfy predetermined restriction conditions and can be targets of the aggregation by searching for storage bins with high filling rates for aggregation using a storage bin with a low filling rate for aggregation, for example, as a core. The predetermined restriction conditions are either or both the condition that at least one empty slot is created in the storage bins after the aggregation and the condition that the filling rate for aggregation after addition does not exceed 100%.

In a case where there is a combination of storage bins in step St6 (St7, YES), the processing of processing device 11 proceeds to step St8. On the other hand, in a case where there is no combination of storage bins in step St6 (St7, NO), it is determined that there are no storage bins as targets of aggregation, and the processing of processing device 11 is ended.

Processing device 11 determines, for each combination of storage bins determined in step St6, work priority in a case where the combination of the storage bins is aggregated in accordance with the above-described work priority determination criteria (St8). Processing device 11 generates an execution instruction of aggregation including the determination result in step St8 and externally transmits the execution instruction to handy terminal 50 gripped by the worker or AGV 60 (St9). As a result, the worker or AGV 60 who or that has been able to confirm the reception of the execution instruction of aggregation can aggregate the corresponding combination of the storage bins in accordance with the work priority designated by the execution instruction.

### Supplementary Notes

The above description of the exemplary embodiments discloses the technical ideas described in the following items.

### Item 1

A warehouse management apparatus including:
a processor (processing device 11, for example);
a memory (storage 12, for example); and
a communication unit (communication device 13, for example) that performs communication with a warehouse management system (WMS 20, for example) that holds information related to one or more storage bins (storage bins BIN1, BIN2, for example) for accommodating articles to be stored in automated warehouse (70),
wherein the processor cooperates with the memory to
derive inventory turnover days of the articles accommodated in each of the storage bins based on information related to the plurality of storage bins received by the communication unit from the warehouse management system,
determine a combination of a plurality of storage bins to be aggregated based on a result of deriving the inventory turnover days of the articles and filling rates of the articles in the storage bins, and
transmit an execution instruction of aggregation based on the combination to a terminal (handy terminal 50, for example) gripped by a worker in the automated warehouse or a conveyance device (AGV 60, for example) moving in the automated warehouse.

With this configuration, the warehouse management apparatus can accurately determine the combination of the storage bins that can be targets of the aggregation by focusing on the inventory turnover days of the articles accommodated in the storage bins and the filling rates of the articles in the storage bins, can thus efficiently realize aggregation of the storage bins that store the articles stored in the automated warehouse, and can improve operation efficiency of the storage bins.

### Item 2

The warehouse management apparatus according to Item 1,
in which, the information related to the storage bins includes information related to current inventory quantities and delivery frequencies of the articles accommodated in the storage bins, and
the inventory turnover days are derived from products of the current inventory quantities and the delivery frequencies of the articles.

With this configuration, the warehouse management apparatus can easily calculate the inventory turnover days of the articles accommodated in the storage bins using the information acquired from the WMS.

### Item 3

The warehouse management apparatus according to Item 1,
in which the filling rates of the articles in the storage bins are received by the communication unit from the warehouse management system.

With this configuration, the warehouse management apparatus can appropriately determine the combination of the storage bins that can be targets of the aggregation using the filling rates theoretically calculated in the warehouse management system on the basis of the inventory quantities of the articles accommodated in the storage bins stored in the warehouse management system.

### Item 4

The warehouse management apparatus according to Item 1,
in which the communication unit performs communication with a measurement system (30) that images the storage bins, and
the processor derives the filling rates of the articles in the storage bins based on captured images of the storage bins captured by the measurement system.

With this configuration, the warehouse management apparatus can appropriately determine the combination of the storage bins that can be targets of the aggregation using the filling rates obtained based on the captured images obtained by imaging the storage bins stored in the automated warehouse in real time.

### Item 5

The warehouse management apparatus according to any one of Items 1 to 3,
in which the processor extracts a plurality of storage bins that accommodate articles with results of deriving the inventory turnover days within a predetermined range as candidates for the combination.

With this configuration, the warehouse management apparatus can select, in the selection of the candidates that can be targets of the aggregation of the storage bins, the candidates with the inventory turnover days that are not too short and not too long and are within the predetermined range and can thus realize efficient aggregation of the storage bins.

### Item 6

The warehouse management apparatus according to any one of Items 1 to 4,
in which in a case where a plurality of the combinations are present, the processor determines work priority of the aggregation for each of the combinations and transmits the determined work priority with the work priority included in the execution instruction.

With this configuration, the warehouse system can provide an accurate instruction regarding which combination of storage bins is to be preferentially aggregated in the case where there are a plurality of combinations of storage bins that can be targets of the aggregation.

### Item 7

The warehouse management apparatus according to any one of Items 1 to 5,
in which the processor derives a filling rate of each of storage bins to be targets of aggregation based on a scheduled number of articles to be warehoused in the automated warehouse and current filling rates of the articles in the storage bins and determines the combination using a derived result.

With this configuration, the warehouse management apparatus can obtain the filling rates as more realistic values in consideration of the scheduled number of articles to be warehoused in the automated warehouse on the day and to be accommodated in any of the storage bins, and can appropriately determine the combination of the storage bins that can be targets of the aggregation.

### Item 8

A storage bin aggregation method including:
causing a processor and a memory to cooperate to
perform communication with a warehouse management system that holds information related to one or more storage bins for accommodating articles to be stored in an automated warehouse,
derive inventory turnover days of the articles accommodated in each of the storage bins based on the information related to the plurality of storage bins received from the warehouse management system,
determine a combination of a plurality of storage bins to be aggregated based on a result of deriving the inventory turnover days of the articles and filling rates of the articles in the storage bins, and
transmit an execution instruction of aggregation based on the combination to a terminal gripped by a worker in the automated warehouse or a conveyance device moving in the automated warehouse.

With this configuration, according to the storage bin aggregation method, it is possible to accurately determine the combination of the storage bins that can be targets of the aggregation by focusing on the inventory turnover days of the articles accommodated in the storage bins and the filling rates of the articles in the storage bins, to thereby efficiently realize aggregation of the storage bins that store the articles stored in the automated warehouse, and to improve operation efficiency of the storage bins.

### Item 9

A program that causes a warehouse management apparatus that is a computer to perform processing of:
performing communication with a warehouse management system that holds information related to one or more storage bins for accommodating articles to be stored in an automated warehouse,
deriving inventory turnover days of the articles accommodated in each of the storage bins based on the information related to the plurality of storage bins received from the warehouse management system,
determining a combination of a plurality of storage bins to be aggregated based on a result of deriving the inventory turnover days of the articles and filling rates of the articles in the storage bins, and
transmitting an execution instruction of aggregation based on the combination to a terminal gripped by a worker in the automated warehouse or a conveyance device moving in the automated warehouse.

With this configuration, the warehouse management apparatus that can execute the program can accurately determine the combination of the storage bins that can be targets of the aggregation by focusing on the inventory turnover days of the articles accommodated in the storage bins and the filling rates of the articles in the storage bins, can thus efficiently realize aggregation of the storage bins that store the articles stored in the automated warehouse, and can improve operation efficiency of the storage bins.

A program and a storage medium adapted such that the program implementing the functions of the device of the above-described exemplary embodiment is supplied to a device via a network or any of various storage media and a computer in the device reads and executes the program are also within the range of applications of the present disclosure.

Although the various exemplary embodiments have been described above with reference to the drawings, it goes without saying that the present disclosure is not limited to such examples. It is obvious that those skilled in the art can achieve various change examples, modification examples, replacement examples, addition examples, deletion examples, and equivalent examples within the scope described in the claims, and it is understood that these examples naturally belong to the technical scope of the present disclosure. In addition, the constituent elements included in the various exemplary embodiments described above may be voluntarily combined within the scope not departing from the gist of the present disclosure.

The present disclosure is effective as the warehouse management apparatus, the storage bin aggregation method, and the program that efficiently realize aggregation of storage bins that store articles stored in the automated warehouse and improve operation efficiency of the storage bins.

What is claimed is:

1. A warehouse management apparatus comprising:
a processor;
a memory; and
a communication unit that performs communication with a warehouse management system that holds information related to one or more storage bins for accommodating articles to be stored in an automated warehouse,
wherein the processor cooperates with the memory to
derive inventory turnover days of the articles accommodated in each of the storage bins based on information related to the plurality of storage bins received by the communication unit from the warehouse management system,
determine a combination of a plurality of storage bins to be aggregated based on a result of deriving the inventory turnover days of the articles and filling rates of the articles in the storage bins, and
transmit an execution instruction of aggregation based on the combination to a terminal gripped by a worker in the automated warehouse or a conveyance device moving in the automated warehouse.

2. The warehouse management apparatus according to claim 1,
wherein the information related to the storage bins includes information related to current inventory quantities and delivery frequencies of the articles accommodated in the storage bins, and
the inventory turnover days are derived from products of the current inventory quantities and the delivery frequencies of the articles.

3. The warehouse management apparatus according to claim 1,
wherein the filling rates of the articles in the storage bins are received by the communication unit from the warehouse management system.

4. The warehouse management apparatus according to claim 1,
wherein the communication unit performs communication with a measurement system that images the storage bins, and
the processor derives the filling rates of the articles in the storage bins based on captured images of the storage bins captured by the measurement system.

5. The warehouse management apparatus according to claim 1,
wherein the processor extracts a plurality of storage bins that accommodate articles with results of deriving the inventory turnover days within a predetermined range as candidates for the combination.

6. The warehouse management apparatus according to claim 1,
wherein in a case where a plurality of the combinations are present, the processor determines work priority of the aggregation for each of the combinations and transmits the determined work priority with the work priority included in the execution instruction.

7. The warehouse management apparatus according to claim 1,
wherein the processor derives a filling rate of each of storage bins to be targets of aggregation based on a scheduled number of articles to be warehoused in the automated warehouse and current filling rates of the articles in the storage bins and determines the combination using a derived result.

8. A storage bin aggregation method including:
causing a processor and a memory to cooperate to
perform communication with a warehouse management system that holds information related to one or more storage bins for accommodating articles to be stored in an automated warehouse,
derive inventory turnover days of the articles accommodated in each of the storage bins based on the information related to the plurality of storage bins received from the warehouse management system,
determine a combination of a plurality of storage bins to be aggregated based on a result of deriving the inventory turnover days of the articles and filling rates of the articles in the storage bins, and
transmit an execution instruction of aggregation based on the combination to a terminal gripped by a worker in the automated warehouse or a conveyance device moving in the automated warehouse.

9. A program that causes a warehouse management apparatus that is a computer to perform processing of:
performing communication with a warehouse management system that holds information related to one or more storage bins for accommodating articles to be stored in an automated warehouse,
deriving inventory turnover days of the articles accommodated in each of the storage bins based on the information related to the plurality of storage bins received from the warehouse management system,
determining a combination of a plurality of storage bins to be aggregated based on a result of deriving the inventory turnover days of the articles and filling rates of the articles in the storage bins, and
transmitting an execution instruction of aggregation based on the combination to a terminal gripped by a worker in the automated warehouse or a conveyance device moving in the automated warehouse.
